(19) United States
(12) Patent Application Publication
(10) Pub. No.: US 2015/0333573 A1
(43) Pub. Date: Nov. 19, 2015

(54) WIRELESS SOUND POWER DISTRIBUTION SYSTEM FOR LAW ENFORCEMENT EQUIPMENT

(71) Applicant: Energous Corporation, San Jose, CA (US)

(72) Inventor: Michael A. Leabman, Pleasanton, CA (US)

(21) Appl. No.: 14/276,811

(22) Filed: May 13, 2014

(51) Int. Cl. H02J 17/00; H02J 7/02

(52) U.S. Cl. CPC H02J 17/00; H02J 7/025

(57) ABSTRACT

A wireless sound power distribution system for Law Enforcement equipment is disclosed. The system includes a wireless power transmitter coupled with a power source. The transmitter may form pockets of energy using controlled sound waves. Electrical equipment coupled with an electronic receiver may utilize pockets of energy formed by the transmitter to Charge or power the electrical equipment. The transmitter coupled with a power source may be carried in a vehicle for portability.

### CROSS-REFERENCES TO RELATED APPLICATIONS

The present disclosure is related to U.S. non-provisional patent application No. 13/891,430, filed May 10, 2013, entitled “Methodology for Pocket-forming”; Ser. No. 13/925,469 filed Jun. 24, 2013, entitled “Methodology for Multiple Pocket-Forming”; Ser. No. 13/946,082 ,filed Jul. 19, 2013, entitled “Method for 3 Dimensional Pocket-forming”; Ser. No. 13/891,399, filed Jul. 22, 2013, entitled “Receivers for Wireless Power Transmission”; and Ser. No. 13/891,445. filed Jul. 22, 2013, entitled “Transmitters for Wireless Power Transmission”.

### FIELD OF INVENTION

The present disclosure relates to wireless power distribution, and more particularly, to wireless sound power distribution on law enforcement equipment,

### BACKGROUND OF THE INVENTION

Law enforcement officers are typically required to carry a great deal of equipment when they are on the field. In addition to a gun, handcuff's and batons, a law enforcement officer is often required to carry many electrical devices in the performance of his/her duties. For instance, police patrol officers or a squad of policemen who have been trained to deal with a violent and dangerous situations (SWAT teams) need to carry radios or walkie talkies, flash lights, wearable cameras, GPS, wireless communication. earpiece systems, portable digital video recorders (DVRs), night vision goggles, rifle scopes and/or any other law enforcement equipment that may require an electrical power source, All the electrical devices described above may require to be constantly charged, for this reason law enforcement officers may need to carry extra batteries for these devices; however, carrying batteries may not only add additional weight to the equipment each officer carries but also may be troubling and impractical in some situations.

Thus, a need exists for an electrical power source that addresses the aforementioned issues.

### SUMMARY OF THE INVENTION

The present disclosure is a wireless sound power distribution system for Law Enforcement equipment. Law Enforcement officers may be required to carry a great deal of equipment which in most cases are electrical devices, the wireless power distribution system disclosed here may charge or power the electrical devices wirelessly by following the pocket-forming methodology, which is also included here by reference. In one embodiment, the wireless power distribution system may include at least one transmitter coupled with any suitable battery management system in a Law Enforcement vehicle, in another embodiment, a Law Enforcement uniform may be coupled with wireless receiver components that may use the pockets of energy to charge or power the electrical devices. The wireless power distribution system may avoid tedious wired connections and may be more easily installed and uninstalled. Furthermore, the wireless power distribution system may eliminate the need for Law Enforcement officers to carry extra batteries for the electrical devices they use during the performance of their duties.

A method for wireless power transmission for electrical devices used by law enforcement equipment, comprising the steps of: connecting a pocket-forming transmitter having transducer elements, a sound wave (SW) circuit, a digital signal processor for controlling the SW circuit of the transmitter and communication circuitry to at least one mobile power source; generating power SW waves from the SW circuit in the transmitter; controlling the generated power SW waves with the digital signal processor in the transmitter; transmitting the power SW waves through transducer elements of the transmitter to a predefined range from the mobile power source; integrating a receiver with communication circuitry and sensor elements in a law enforcement uniform; and capturing the power SW waves forming pockets of energy converging in 3-D space at the receiver in the uniform; and connecting the electrical devices to the receiver in the uniform to power the electrical devices.

In other embodiment the wireless power distribution system may be used to charge or power remote controlled vehicles that are often used for espionage, detecting mines or disabling bombs

Numerous other aspects, features and benefits of the present disclosure may be made apparent from the following detailed description taken together with the drawing figures.

### BRIEF DESCRIPTION OF THE DRAWINGS

Embodiments of the present disclosure are described by way of example with reference to the accompanying figures, which are schematic and are not intended to he drawn to scale. Unless indicated as representing prior art, the figures represent aspects of the present disclosure.

FIG. 1 illustrates wireless power transmission using pocket-forming, according to an embodiment.

FIG. 2 illustrates a component level embodiment for a transmitter, according to an embodiment.

FIG. 3 illustrates a component level embodiment for a receiver, according to an embodiment.

FIG. 4 illustrates a law enforcement officer wearing a uniform with an integrated wireless power receiver, according to an embodiment.

FIG. 5 illustrates a mobile power source for police officers, according to an embodiment.

FIG. 6 illustrates a mobile power source for SWAT teams, according to an embodiment.

FIG. 7 illustrates a mobile power source for remote controlled vehicles, according to an embodiment

### DETAILED DESCRIPTION OF THE DRAWINGS

### Definitions

“Pocket-forming” may refer to generating two or more SW waves which converge in 3-d space, forming controlled constructive and destructive interference patterns.

“Pockets of energy” may refer to areas or regions of space where energy or power may accumulate in the form of constructive interference patterns of SW waves.

“Null-space” may refer to areas or regions of space where pockets of energy do not form because of destructive interference patterns of SW waves.

“Transmitter” may refer to a device, including a chip which may generate two or more SW signals, at least one SW signal being phase shifted and gain adjusted with respect to other SW signals, substantially all of which pass through one or more SW transducer such that focused SW signals are directed to a target.

“Receiver” may refer to a device which may include at least one sensor, at least one rectifying circuit and at least one power converter for powering or charging an electronic device using SW waves.

“Adaptive pocket-forming” may refer to dynamically adjusting pocket-forming to regulate power on one or more targeted receivers.

### DESCRIPTION OF THE DRAWINGS

In the following detailed description, reference is made to the accompanying drawings, which form a part hereof. In the drawings, which may not be to scale or to proportion, similar symbols typically identify similar components, unless context dictates otherwise. The illustrative embodiments described in the detailed description, drawings and claims, are not meant to be limiting. Other embodiments may be used and/or and other changes may be made without departing from the spirit or scope of the present disclosure.

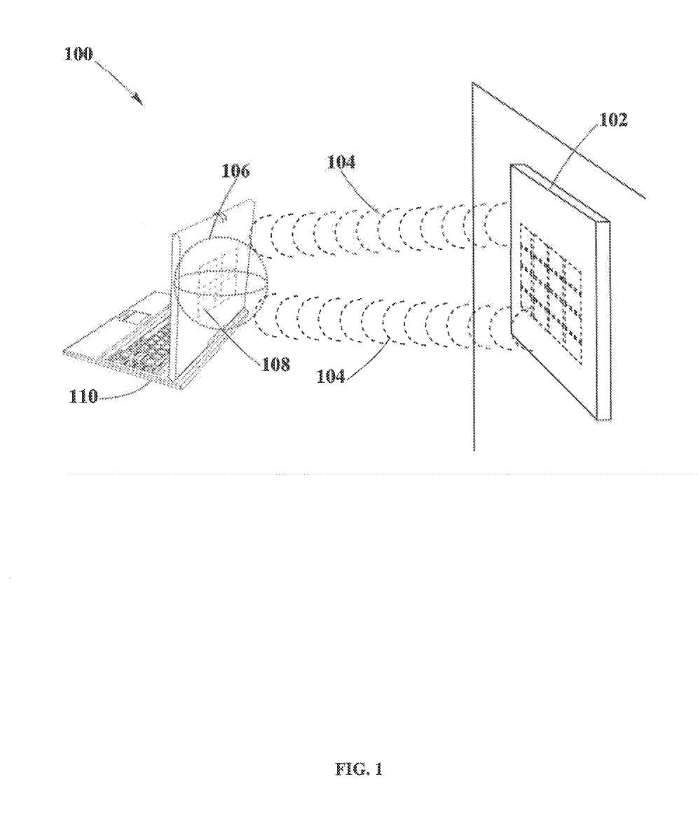

FIG. 1 illustrates wireless power transmission 100 using pocket-forming. A transmitter 102 may transmit controlled sound waves 104 which may converge in 3-d space. These SW waves may be controlled through phase and/or relative amplitude adjustments to form constructive and destructive interference patterns (pocket-forming). Pockets of energy 106 may form at constructive interference patterns and can be 3-dimensional in shape whereas null-spaces may be generated at destructive interference patterns. A receiver 108 may then utilize pockets of energy produced by pocket-forming for charging or powering an electronic device, for example a laptop computer 110 and thus effectively providing wireless power transmission 100. In some embodiments, there can be multiple transmitters 102 and/or multiple receivers 108 for powering various electronic devices, for example smartphones, tablets, music players, toys and others at the same time. In other embodiments, adaptive pocket-forming may be used to regulate power on electronic devices.

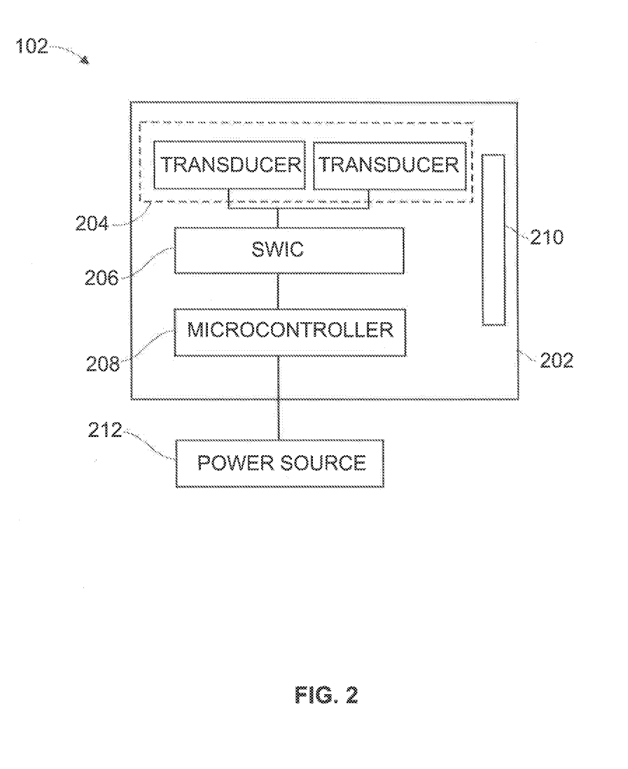

FIG. 2 illustrates a component level embodiment for a transmitter 200 which may be utilized to provide wireless power transmission 100 as described in FIG. 1, Transmitter 200 may include a housing 2.02 where at least two or more transducer elements 204, at least one SW integrated circuit (SWIC 206), at least one digital signal processor (DSP) or micro-controller 208, and one optional communications component 210 may be included. Housing 202 can be made of any suitable material which may allow for signal or wave transmission and/or reception, for example plastic or hard rubber. Transducer elements 204 may include suitable transducer types for operating in frequency bands such as 10 KHz to 50 KHz as these frequency bands conform to a desirable frequencies for charging electronic devices. Other transducer elements 204 types can be used, for example piezoelectric transducers among others. SWIC 206 may include a proprietary chip for adjusting phases and/or relative magnitudes of SW signals which may serve as inputs for transducer elements 204 for controlling pocket-forming, These SW signals may be produced using an external power supply 212 and a local oscillator chip (not shown) using the suitable piezoelectric material. Micro-controller 208 may then process information sent by a receiver through its own communication antenna element for determining optimum times and locations for pocket-forming. In some embodiments, the foregoing may be achieved through communications component 210. Communications component 210 may be based on standard wireless communication protocols which may include Bluetooth, Wi-Fi or ZigBee. In addition, communications component 210 may be used to transfer other information such as an identifier for the device or user, battery level, location or other such information. Other communications component 210 may be possible which may include radar, infrared cameras or sound devices for sonic triangulation for determining the device's position.

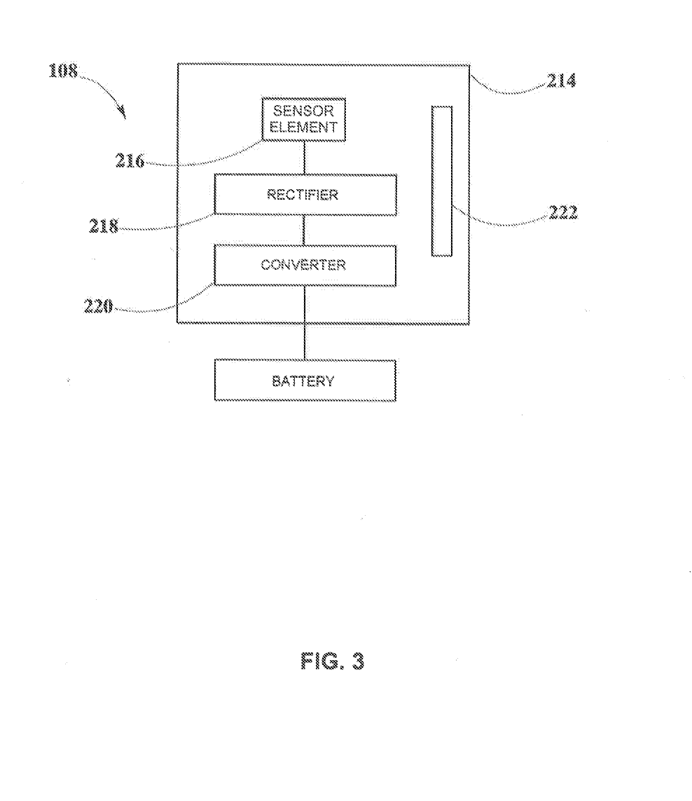

FIG. 3 illustrates a component level embodiment for a. receiver 300 which can be used for powering or charging an electronic device as exemplified in wireless power transmission 100. Receiver 300 may include a housing 302 where at least one sensor element 304, one rectifier 306, one power converter 308 and an optional communications component 310 may be included, Housing 302 can be made of any suitable material which may allow for signal or wave transmission and/or reception, for example plastic or hard rubber. Housing 302 may be an external hardware that may be added to different electronic equipment, for example in the form of cases, or can be embedded within electronic equipment as well. Sensor element 304 may include suitable sensor types for operating in frequency bands similar to the bands described for transmitter 200 from FIG. 2. Sensor element 304 includes several sensors in an array for configuring the sensors in a preferred orientation during usage or whose orientation may vary continuously through time, for example a smartphone or portable gaming system. On the contrary, for devices with well-defined orientations, for example a two-handed video game controller, there might be a preferred orientation for sensors Which may dictate a ratio for the number of sensors of a given orientation, Suitable senor types may include piezoelectric sensors, The receiver 300, may dynamically modify its sensors to optimize wireless power transmission. Rectifier 306 may include diodes or resistors, inductors or capacitors to rectify the alternating current (AC) voltage generated by transducer element 304 to direct current (DC) voltage, Rectifier 306 may be placed as close as is technically possible to sensor element 304 to minimize losses, After rectifying AC voltage, DC voltage may be regulated using power converter 308. Power converter 308 can be a DC-DC converter which may help provide a constant voltage output, regardless of input, to an electronic device, or as in this embodiment to a battery 312. Typical voltage outputs can be from about 5 volts to about 10 volts, Lastly, communications component 310, similar to that of transmitter 200 from FIG. 2, may be included in receiver 300 to communicate with a transmitter 200 or to other electronic equipment.

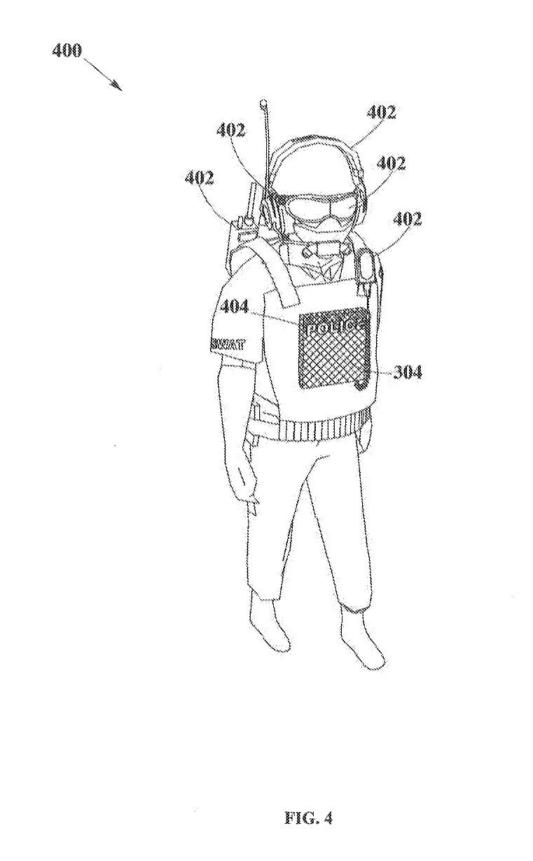

FIG. 4 illustrates a law enforcement officer wearing a uniform with an integrated receiver 400, similar to receiver 300 described in FIG, 3, Uniform with an integrated receiver 400 may include electrical devices 402 such as radios, night vision goggles, and wearable cameras among others. Electrical devices 402 may be coupled to receiver 404 through wires strategically distributed in the uniform. Receiver 404 may then have an array of sensor elements 304 distributed on the grid area, as shown in FIG. 4, to receive pockets of energy 106, Receiver 404 may then utilize pockets of energy 106 produced by pocket-forming for charging or powering electrical devices 402.

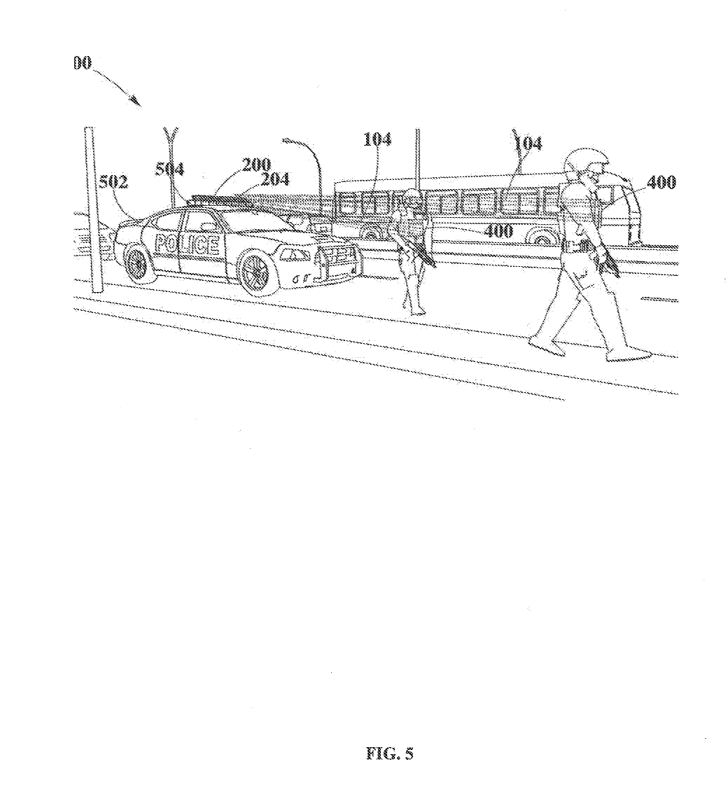

FIG. 5 illustrates a mobile power source 500 for police officers wearing uniforms with an integrated receiver 400, as described in FIG. 4, Mobile power source 500 may also serve electrical devices 402 coupled with receivers 300 independently.

In FIG. 5, a police car 502 may include a transmitter 200 which may be placed on top of siren 504, as shown in FIG. 5, Transmitter 200 may be coupled to any suitable battery management system in police car 502 to get the power necessary to enable wireless power transmission 100. Transmitter 200 may include an array of transducer elements 204 which may be distributed along the edge of the structure located on top of siren 504, as shown in FIG. 5, Transmitter 200 may then transmit controlled sound waves 104 which may converge in 3-d space, These SW waves may be controlled through phase and/or relative amplitude adjustments to form constructive and destructive interference patterns (pocket-forming). Uniforms with an integrated receiver 400 may then utilize pockets of energy 106 produced by pocket-forming for charging or powering electrical devices 402.

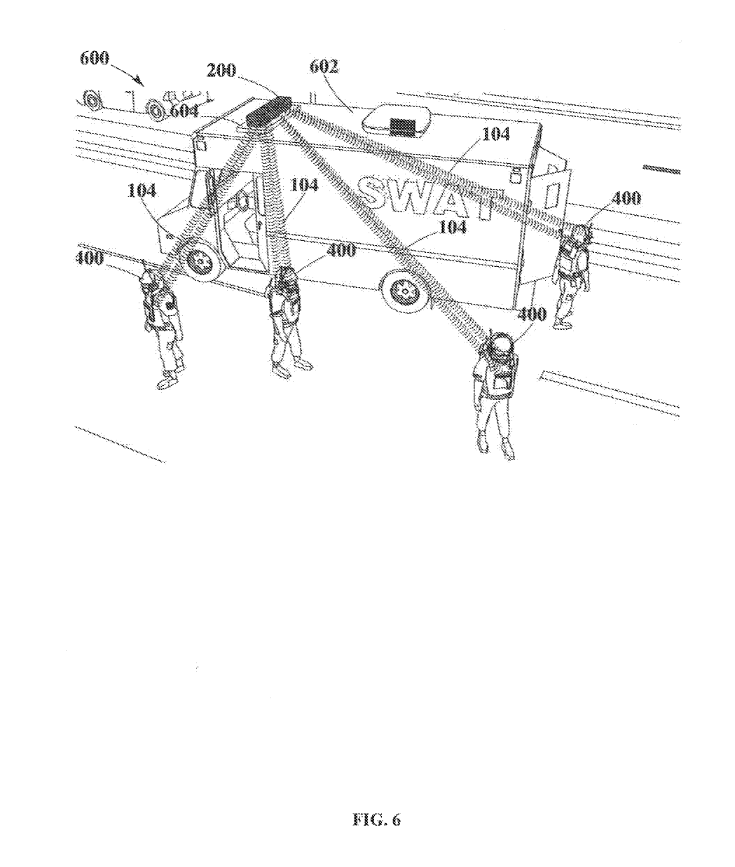

FIG. 6 illustrates a mobile power source 600 for specialized police officers wearing uniforms with an integrated receiver 400, as described in FIG. 4. Mobile power source 600 may also serve electrical devices 402 coupled with receivers 300 independently.

In FIG. 6, a SWAT Mobile Command Truck 602. may include a transmitter 200 which may be placed on top of siren 604, as shown in FIG. 6. Transmitter 200 may he coupled to any suitable battery management system in SWAT Mobile Command Truck 602 to get the power necessary to enable wireless power transmission. 100. Transmitter 200 may include an array of transducer elements 204 which may be distributed along the edge of the structure located on top of siren 604, as shown in FIG, 6. Transmitter 200 may then transmit controlled sound waves 104 which may converge in 3-d space. These SW waves may be controlled through phase and/or relative amplitude adjustments to form constructive and destructive interference patterns (pocket-forming). Uniforms with an integrated receiver 400 may then utilize pockets of energy 106 produced by pocket-forming for charging or powering electrical devices 402.

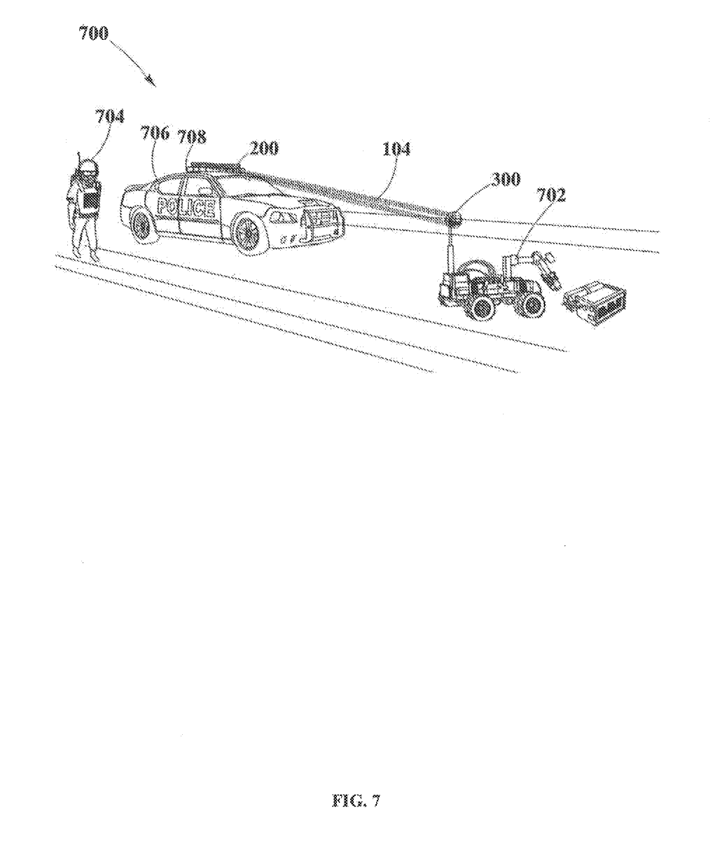

FIG. 7 illustrates a mobile power source 700 for remote controlled vehicles 702 designed for espionage, detecting mines or disabling bombs may be powered wirelessly. In this embodiment, remote control and power may be critical factors to prevent exposure or harm to police officers 704. In FIG. 7, a police car 706 may include a transmitter 200 which may be placed on top of siren 708, as shown in FIG. 7. Transmitter 200 may be coupled to any suitable battery management system in police car 706 to get the power necessary to enable wireless power transmission 100. Transmitter 200 may include an array of transducer elements 204 Which may be distributed along the edge of the structure located on top of siren 708, as shown in FIG. 7. Transmitter 200 may then transmit controlled sound waves 104 which may converge in 3-d space. These SW waves may be controlled through phase and/or relative amplitude adjustments to form constructive and destructive interference patterns (pocket-forming). Remote controlled vehicle 702 may be coupled with a receiver 300. A receiver 300 may then utilize pockets of energy 106 produced by pocket-forming for charging or powering remote controlled vehicle 702.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

Having thus described the invention, I claim:

1. A method for wireless power transmission for electrical devices used by law enforcement equipment, comprising the steps of:
emitting SW waves from a pocket-forming transmitter each having a sound wave integrated circuit, transducer elements, and communication circuitry;
generating pockets of energy from the transmitter to converge in 3-d space at predetermined locations within a predefined range;
incorporating a receiver within a law enforcement uniform;
attaching the electrical devices to the receiver; and
convening the pockets of energy in 3-d space from the transmitter to the receiver located within the law enforcement uniform to charge or power the electrical devices.

2. The method for wireless power transmission for electrical devices used by law enforcement equipment of claim 1, wherein the electrical devices are radios, night vision goggles, wearable cameras, flashlights, sensors and other portable law enforcement electrical devices for use in law enforcement.

3. The method for wireless power transmission for electrical devices used with law enforcement equipment of claim 1, wherein the electrical devices are coupled to the receiver through wires strategically distributed in the uniform.

4. The method for wireless power transmission for electrical devices used by law enforcement equipment of claim 1, wherein the transmitter and receiver include transducer and sensor elements, respectively.

5. The method for wireless power transmission for electrical devices used by law enforcement equipment of claim 4, wherein the receiver sensor elements are in an array.

6. The method for wireless power transmission for electrical devices used by law enforcement equipment of claim 5, further including the step of distributing the receiver sensor elements in a grid area on the uniform to receive the pockets of energy and the step of utilizing the pockets of energy from the pocket-forming transmitter to manage power requirements of each of the electrical devices.

7. The method for wireless power transmission for electrical devices used by law enforcement. equipment of claim 4, wherein the transducer elements of the transmitter and receiver operate in frequency bands of 10 KHz to 50 KHz in addition to the other approved law enforcement frequency hands.

8. The method for wireless power transmission for electrical devices used by law enforcement equipment of claim 1, wherein the communication circuitry are communication components including radar, infrared cameras or sound devices for sonic triangulation for determining the location of the receiver on the uniform.

9. The method for wireless power transmission for electrical devices used by law enforcement equipment of claim 1, wherein the receiver is integrated into the uniform of law enforcement.

10. The method for wireless power transmission for electrical devices used by law enforcement equipment of claim I, wherein the transmitter is connected to a mobile power source for generating pockets of energy from the transmitter to converge in 3-d space at predetermined locations within the predefined range for the receiver on the uniform.

11. The method for wireless power transmission for electrical devices used by law enforcement equipment of claim 1, wherein the transmitter is placed on top of a mobile vehicle and further including the step of coupling the transmitter to a suitable battery management system located within the vehicle to enable wireless power transmission.

12. A method for wireless power transmission for electrical devices used by law enforcement equipment, comprising the steps of:
connecting a pocket-forming transmitter having transducer elements, a SW circuit, a digital signal processor for controlling the SW circuit of the transmitter and communication circuitry to at least one mobile power source;
generating power SW waves from the SW circuit in the transmitter;
controlling the generated power SW waves with the digital signal processor in the transmitter;
transmitting the power SW waves through transducer elements of the transmitter to a predefined range from the mobile power source;
integrating a receiver with communication circuitry and transducer elements in a law enforcement uniform;
capturing the power SW waves forming pockets of energy converging in 3-D space at the receiver in the uniform; and
connecting the electrical devices to the receiver in the uniform to power the electrical devices.

13. The method for wireless power transmission for electrical devices used by law enforcement equipment of claim 12, wherein the mobile power source is a battery management system within a motor vehicle.

14. The method for wireless power transmission for electrical devices used by law enforcement equipment of claim 12, further includes the step of communicating information. between the transmitter and receiver through communication circuitry and communication protocols in both the transmitter and receiver to identify the location of the receiver on the uniform for powering the connected electrical devices.

15. The method for wireless power transmission for electrical devices used by law enforcement equipment of claim 12, wherein the digital signal processor is a microprocessor controlling the time emission of pocket-forming, direction of pocket-forming, bounce angle of the pockets of energy, intensity of the pockets of energy when controlling the pocket-forming transmitter and further including the step of transmitting the pockets of energy to multiple receivers located on uniforms within the predetermined range of the transmitter.

16. The method for wireless power transmission for electrical devices used by law enforcement equipment of claim 12, wherein the digital signal processor manages and controls the pockets of energy to the receiver on the uniform by controlling the communication circuitry on the transmitter.

17. The method for wireless power transmission for electrical devices used by law enforcement equipment of claim 12, wherein the mobile power source is a battery management system in the police car and further includes the step of coupling the transmitter mounted on a siren on a top of the police car to the battery management system to enable the wireless power transmission to the receiver integrated into the uniform for powering the electrical devices connected to the receiver in the uniform.

18. The method for wireless power transmission for electrical devices used by law enforcement equipment of claim 12, wherein the power to SW waves are managed by the digital signal processor to produce power SW waves in a wide variety of frequencies, wavelength, intensities and other SW characteristics for powering the electrical devices connected to the receiver on the uniform.

19. The method for wireless power transmission for electrical devices used by law enforcement equipment of claim 12, wherein the mobile power source and transmitter are mounted on a vehicle configured to power multiple receivers located on multiple uniforms within the predefined range to power the electrical devices connected to the multiple receivers.

20. The method for wireless power transmission for electrical devices used by law enforcement equipment of claim 12, wherein the communication circuitry uses standard wireless communication protocols such as Bluetooth, WiFi, Zigbee or FM radio between the transmitter and receiver.

21. The method for wireless power transmission for electrical devices used by law enforcement equipment of claim 12, wherein the transducer elements in the transmitter and the sensor elements in the receiver operate in the frequency bands of 10 KHz to 50 KHZ.

22. The method for wireless power transmission for electrical devices used by law enforcement equipment of claim 12, further includes the step of transmitting pockets of energy to a remote controlled vehicle with the integrated receiver to power the vehicle for espionage, detecting mines or disabling bombs to prevent exposure or harm to law enforcement during such operations.

23. An apparatus for wireless power transmission to an electrical device used by a law enforcement, comprising:
a pocket-forming transmitter having transducer elements, a SW circuit, a digital signal processor for controlling the SW circuit of the transmitter and communication circuitry connected to at least one mobile power source;
power SW waves generated from the SW circuit in the transmitter;
a digital signal processor in the transmitter for controlling the generated power SW waves;
pockets of energy configured from the power SW waves controlled by the digital signal processor and transmitted through transducer elements of the transmitter to a predefined range from the mobile power source;
a receiver with communication circuitry and sensor elements integrated in a law enforcement uniform for capturing the pockets of energy converging in 3-D space at the receiver in the uniform; and
wherein the electrical devices are coupled to the receiver in the uniform to power the electrical devices.

24. The apparatus for wireless power transmission to an electrical device used by a law enforcement 23, wherein the transmitter and receiver communication circuitry utilizes Bluetooth, infrared, FM radio or Zigbee signals for the various communication protocols between the receiver and the transmitter.

25. The apparatus for wireless power transmission to an electronic device of claim 23, wherein the mobile power source is a battery management system within the law enforcement vehicle for powering any electrical device coupled to the integrated receiver within the uniform to the transmitter predefined range.
